(19) United States
(12) Patent Application Publication
(10) Pub. No.: US 2016/0063617 A1
(43) Pub. Date: Mar. 3, 2016

(54) Occupancy Monitoring For A Remote Short Term Housing Rental.

(71) Applicant: Mazen Alhakim, Cape Coral, FL (US)

(72) Inventor: Mazen Alhakim, Cape Coral, FL (US)

(21) Appl. No.: 14/475,604

(22) Filed: Sep. 3, 2014

(51) Int. Cl. G06Q 30/06; G06Q 50/16

(52) U.S. Cl. CPC G06Q 30/0645; G06Q 50/163

(57) ABSTRACT

The present invention involves a remote monitoring system, consisting of a wireless door sensor, a wireless motion sensor, and a Wi-Fi main panel, all installed at a short term housing rental to constantly monitor and inform the owner of the daily rental status; Occupied vs. Vacant, and the Wi-Fi main panel communicating with the owner smart phone through the internet.

### BACKGROUND OF THE INVENTION

This invention relates to the field of the remote monitoring of the rental status (Occupied vs. Vacant) of remote short term housing rentals.

A short term housing rental could come in different forms such as, time share, condo, beach property, cabin, vacation property, motel, skiing resort and other resort areas.

The owners of these properties live away from them, in some cases out of state, which means the owners need to hire a property manager to manage the daily rentals of these short term rentals. Being away from these properties, the owners have no idea of the daily rental status frequency; the property manager could easily rent the unit and pocket the rental income without the owner's knowledge.

The invention came from a personal bad experience with the property manager of my own out-of-state rental. I had driven all the way to the property, called the property manager on the phone just minutes before I got there and asked about the rental status of the unit. The answer was that the unit is vacant, and when I got there, bad enough the unit was occupied, the manager is pocketing the money and profiting and I am stuck with the expenses.

What is needed therefore is a Wi-Fi monitoring system installed at the property communicating with the owner's smart phone and that will resolve this issue by keeping eye at the property and provide the owner with a solid track of the daily rental status.

### BRIEF SUMMARY OF THE INVENTION

A Wi-Fi monitoring system is installed at a remote short term housing rental to constantly inform the owner of the daily rental status: Occupied vs. Vacant through a smart phone app.

The owner of the property can keep a track record of the daily rental status, in order to collect the due rental income from the property manager without being cheated.

### BRIEF DESCRIPTION OF THE DRAWINGS

The present invention is illustrated by way of example, and not in limitation, in the figures of the accompanying drawings.

For a better understanding of the present invention and its embodiments, reference will be made to the following detailed description, which is to be read in association with the accompanying drawings.

FIG. 1 illustrates is a system diagram of one embodiment of an occupancy monitoring system for a remote short term housing rental, in which a rental unit is vacant.

FIG. 2 illustrates a system diagram of one embodiment of an occupancy monitoring system for a remote short term housing rental, in which a rental unit is occupied.

### DETAILED DESCRIPTION OF THE INVENTION

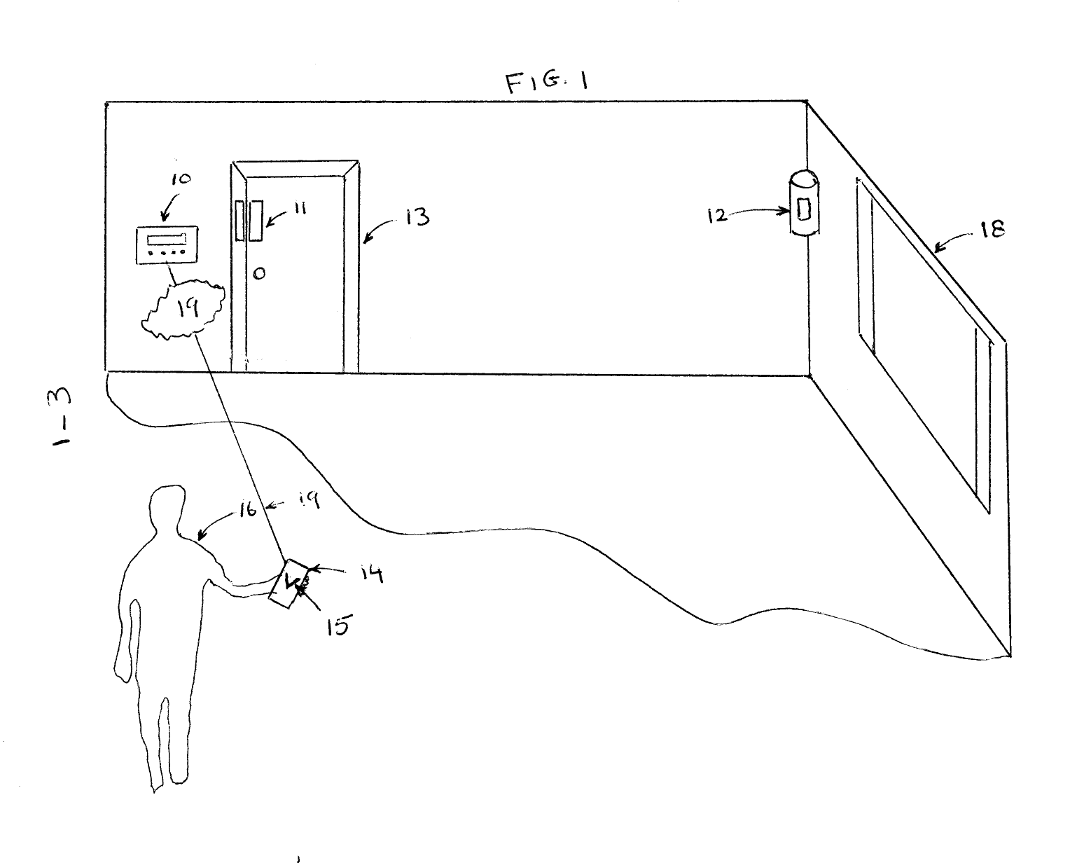

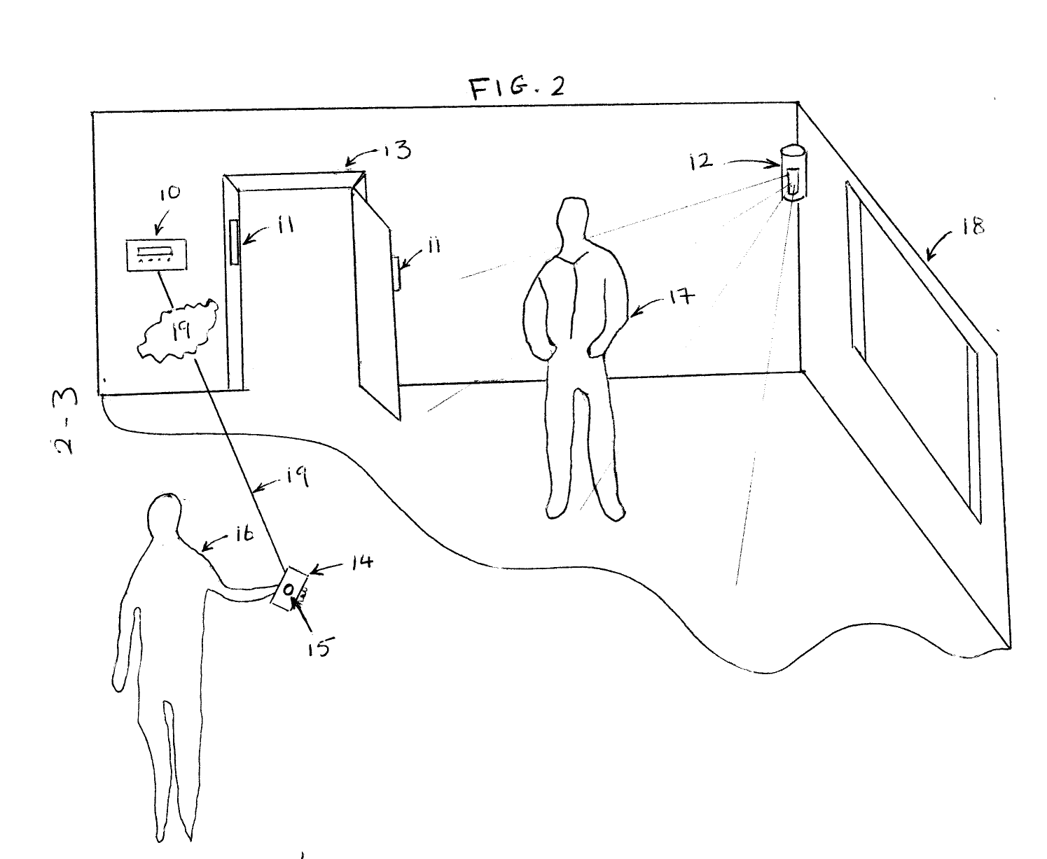

The present invention is designed to monitor the rental status: Occupied vs. Vacant, of a remote short term housing rental, in order for the owner to keep a solid track record of the daily rental status of the property. To that end, the present invention may utilize some hardware as illustrated in FIGS. 1 and 2.

FIG. 1 illustrates the rental unit 18, with a monitoring system installed, which consist of Wi-Fi main panel 1 constantly monitoring and may connect through Wi-Fi or hard wire, wireless door sensor 11, and a wireless motion sensor 12 (just one is shown) as FIG. 1 shows the rental unit 18 is vacant, main door 13 is closed and secure, wireless entry door 11 is undisturbed, wireless motion sensor 12, is undisturbed, the Wi-Fi main panel 10 is communicating through the internet 19, with the smart phone 14, and the smart phone app 15 showing V (vacant) which is seen by the unit owner 16.

FIG. 2 Illustrates the rental unit 18, with a monitoring system installed, which consist of Wi-Fi main panel 10, constantly monitoring and may connect through Wi-Fi or hard wire, wireless door sensor 11, and a wireless motion sensor 12, just one is shown, as FIG. 2 shows the rental unit 18 is occupied by a tenant 17, when tenant 17 opens the main door 13, the wireless entry door sensor 11, alert the Wi-Fi main panel, in addition the wireless motion sensor 12 is activated by the tenant 17 and alerting the Wi-Fi main panel, the Wi-Fi main panel 10 is communicating through the internet 19, with the smart phone 14, and the smart phone app 15 showing O (Occupied) which is seen by the unit owner 16.

What is claimed is:

1. A method and system to constantly and remotely monitor the rental status, Occupied vs. vacant, of a remote short term housing rental, the method comprising: 1-A Wi-Fi monitoring system at the property with the capabilities of sending wireless communication to a portable smart phone.
